(19) United States
(12) Patent Application Publication
(10) Pub. No.: US 2015/0170090 A1
(43) Pub. Date: Jun. 18, 2015

(54) OPTIMIZING EFFICIENCY OF AN ASSET AND AN OVERALL SYSTEM IN A FACILITY

(71) Applicant: Intellisense.io LTD, Cambridge (GB)

(72) Inventors: Sam Gourav Bose, Cambridge (GB); Long Tran-Thanh, Cambridge (GB)

(21) Appl. No.: 14/573,878

(22) Filed: Dec. 17, 2014

(30) Foreign Application Priority Data
Dec. 17, 2013 (GB) 1322316.9

(51) Int. Cl. G06Q 10/06

(52) U.S. Cl. CPC G06Q 10/06395

(57) ABSTRACT

The present disclosure provides a method and a system for monitoring operation of an asset and creating a condition based preventive and predictive maintenance process for the individual asset and overall system. The method and system employ a configuration of sensors within the asset for monitoring physical operating parameters of the asset. In addition, the method and system employ a server arrangement which is operable to receive the sensor signals in substantially real-time. The server arrangement includes processing hardware for processing the sensor signals and is operable to execute one or more software products including computer readable instructions. The software products are operable to analyse the sensor data for determining an aggregate efficiency of operation of the asset based upon a weighted combination of contributions from one or more apparatus of the asset and for providing one or more recommendations for improving the efficiency of operation of the asset.

### CROSS-REFERENCE TO RELATED APPLICATIONS

This application claims the priority benefit of patent application GB 1322316.9 filed Dec. 17, 2013 and entitled ‘System and Method For Optimizing an Efficiency of an Asset and an Overall System in a Facility’ which is incorporated herein by reference in its entirety.

### TECHNICAL FIELD

The present disclosure generally relates to a system for optimizing efficiencies of assets in facilities. Moreover, the present disclosure is also concerned with methods of optimizing efficiencies of assets in facilities. Furthermore, the present disclosure relates to program products also known as software products which have been recorded on non-transient machine-readable data storage media, wherein the software products are executable upon computing hardware for implementing aforesaid methods.

### BACKGROUND

There are many contemporary industrial control systems which enable control and automatization of different assets in a given facility. Such control and automatization not only increases efficiencies of different assets, for example machinery, but also reduces chances of accidents from occurring. In addition, the automatization of the assets helps to reduce energy consumption and improves asset condition in the given facility. Examples of facilities in which these industrial control systems are installed to control different assets include, but not may be limited to, chemical refineries, wafer manufacturing plants and mining operations.

A typical industrial control system includes a simple set of sensors, pre-programmed controllers and a simple set of actuators installed on and/or near different apparatus of an asset in a facility. A large amount of data is collected after pre-defined intervals from these control system and intelligent responses, namely processed data, are generated from the data collected from various assets of an industrial chain of the asset to increase the in situ leaching efficiency of the asset.

Often, a huge number of sensor signals are received in respect of each apparatus of the asset. In addition, simulation models for each of the apparatus of the asset at different operating conditions are utilized. For example, graphs of each of the apparatus at different operating conditions are utilized and an efficiency of each of the apparatus of the facility is determined thereform. Accordingly, the individual efficiency is considered for triggering and generating intelligent responses for increasing the efficiency of the asset. However, the asset has different apparatus working in conjunction with each other at different operating conditions which often makes the asset part of an overall system. So, each of the apparatus may deviate from its optimized efficiency if it were to work in a standalone mode of operation. Therefore, it is difficult to obtain an aggregate indication of overall asset operating efficiency and generating intelligent responses for increasing the efficiency of the asset.

In addition, to generate accurate intelligent responses, relevant consumption data from different sensors, actuators are controllers need to be collected over a long period of time. Moreover, these intelligent responses need to be transmitted in real time to appropriate assets so as to derive a maximum benefit from the responses. In addition, some intelligent responses are critical and should be transmitted at any cost so as to mitigate chances of an unwanted accident. Thus, a system for delivering the intelligent responses as well as collecting data for generating these intelligent responses has to be secure, and accessible at any point of time without any failure. Furthermore, as aforementioned, the volume of data collected from such control systems and generated from technical platforms is very huge and becomes very difficult to handle when it is to be stored and processed. In addition, owing to the criticality associated with industrial installations, the security and accessibility of this data becomes more important.

In view of the aforementioned problems, there is a need for a method and system for determining an operating efficiency of a given asset and the overall system. In addition, the method and system should be able to manage data of industrial control systems in a secure manner, and also provide intelligent responses by accessing the data in real time.

### SUMMARY

The present disclosure seeks to provide a system for monitoring operation of an asset and the overall system on a real time basis.

Moreover, the present disclosure seeks to provide a system to determining an aggregate efficiency of operation of the asset based upon a weighted combination of contributions from one or more apparatus of the one or more assets. The one or more assets make up the overall system, which needs to work in an optimised manner allowing the efficiency and performance benefits to be realised.

Furthermore, the present disclosure seeks to provide a system for triggering recommendations for improving the efficiency of operation of the one or more assets and overall system.

Furthermore, the present disclosure seeks to provide a system to identify adjustments that improve the efficiency of operation of the one or more assets and overall system.

Furthermore, the present disclosure seeks to provide security to the collected data from hacking and provides the real time intelligent responses. The system also seeks to provide a back-up of the data which mitigate the chances of losing the raw and analysed data.

Furthermore, the present disclosure seeks to provide a condition based preventive and predictive maintenance plan for the one or more assets and overall system.

According to a first aspect, there is provided a system for monitoring operation of one or more assets. The system includes a configuration of sensors within the asset for monitoring one or more physical operating parameters of the asset. The sensors are operable to provide corresponding sensor signals for processing within the system. In addition, the system includes a server arrangement which is operable to receive the sensor signals in substantially real-time. The server arrangement includes processing hardware for processing the sensor signals and is operable to execute computer readable instructions of one or more software products. The one or more software products are operable to analyse the sensor data for determining an aggregate efficiency of operation of the asset based upon a weighted combination of contributions from one or more apparatus of the asset, and for providing one or more recommendations for improving the efficiency of operation of the asset. The one or more software products are provided with simulation models of the one or more apparatus of the asset to which the configuration of sensors is applied. The simulation models are employed for identifying adjustments that improve the efficiency of operation of the asset.

There may also be one or more assets comprised in an overall system analysed in a facility that is analysed and optimized.

In an embodiment of the present disclosure, the weighted combination is computed via use of one or more weighting factors. The one or more weighting factors are calculated using an analysis of historical sensor data records for determining a set of values for the one or more weighting factors which enable the aggregate efficiency to be most representative of operation of the asset. In addition, the one or more weighting factor are determined by using an application of operating perturbations to operating conditions of the asset and utilizing a corresponding detected change in the aggregate efficiency for iterating values of the one or more weighting factors for enabling the operating efficiency of the asset to be improved. For determining the one or more weighting factors, the analysis utilizes artificial intelligence, neural network analysis or both.

In an embodiment of the present disclosure, the system further includes one or more backup servers for storing, as data backup security in an event of data failure or corruption within the cloud-computing resource, a record of the sensor signals, the sensor data or both. In another embodiment of the present disclosure, a sub-set of the sensors of the configuration of sensors is coupled wirelessly to the server arrangement.

In an embodiment of the present disclosure, the system is operable to maintain a temporal record of the sensor signals, the sensor data or both. In addition, the system is operable to detect one or more apparatus of the asset monitored by the configuration of sensors, for determining whether the one or more apparatus are operating correctly.

According to a second aspect, a method of operating a system for monitoring operation of an asset is provided. The system includes a configuration of sensors within the asset for monitoring one or more physical operating parameters of the asset. The sensors are operable to provide corresponding sensor signals for processing within the system. The method includes receiving the sensor signals in substantially real-time using a server arrangement. The server arrangement includes processing hardware for processing the sensor signals. In addition, the method includes execution of computer readable instructions of one or more software products using the server arrangement. The one or more software products are operable to analyse the sensor data for determining an aggregate efficiency of operation of the asset based upon a weighted combination of contributions from one or more apparatus of the asset. In addition, the one or more software products are operable to analyse the sensor data for providing one or more recommendations for improving the efficiency of operation of the asset. The one or more software products are provided with simulation models of the one or more apparatus of the asset to which the configuration of sensors is applied. The simulation models are employed for identifying adjustments that improve the efficiency of operation of the asset.

In an embodiment of the present disclosure, the weighted combination is computed via use of one or more weighting factors. In addition, the one or more weighting factor are determined by application of operating perturbations to operating conditions of the asset and utilizing a corresponding detected change in the aggregate efficiency for iterating values of the one or more weighting factors for enabling the operating efficiency of the assets or process such as e.g. in situ leaching to be improved. For determining the one or more weighting factors, the analysis utilizes artificial intelligence, neural network analysis or both.

In an embodiment of the present disclosure, the method further includes one or more backup servers for storing, as data backup security in an event of data failure or corruption within the cloud-computing resource, a record of the sensor signals, the sensor data or both. In another embodiment of the present disclosure, a sub-set of the sensors of the configuration of sensors is coupled wirelessly to the server arrangement.

In an embodiment of the present disclosure, the method is operable to maintain a temporal record of the sensor signals, the sensor data or both. In addition, the system is operable to detect one or more apparatus of the asset monitored by the configuration of sensors, for determining whether the one or more apparatus are operating correctly.

According to a third aspect, a software product is recorded on non-transient machine-readable data storage media and includes computer readable instructions executable upon computing hardware for implementing the method stated above.

It will be appreciated that features of the disclosure are susceptible to being combined in various combinations without departing from the scope of the disclosure as defined by the appended claims.

### DESCRIPTION OF THE DIAGRAMS

Embodiments of the present disclosure will now be described, by way of example only, with reference to the following diagrams wherein:

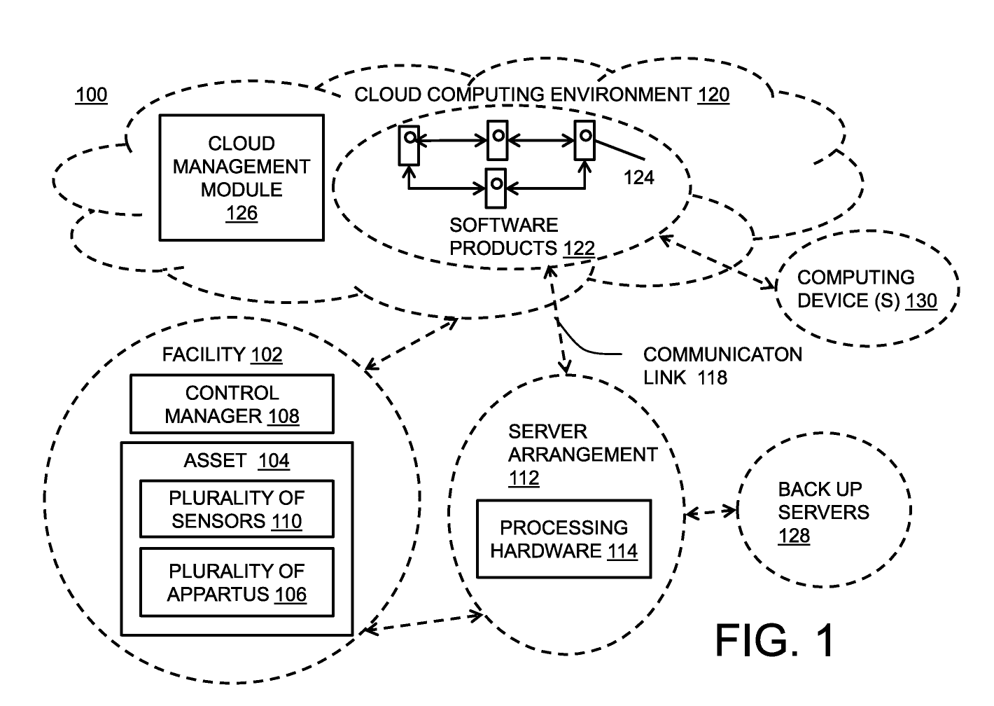

FIG. 1 is an illustration of a system for monitoring operation of an asset utilizing a cloud computing environment, in accordance with various embodiments of the present disclosure;

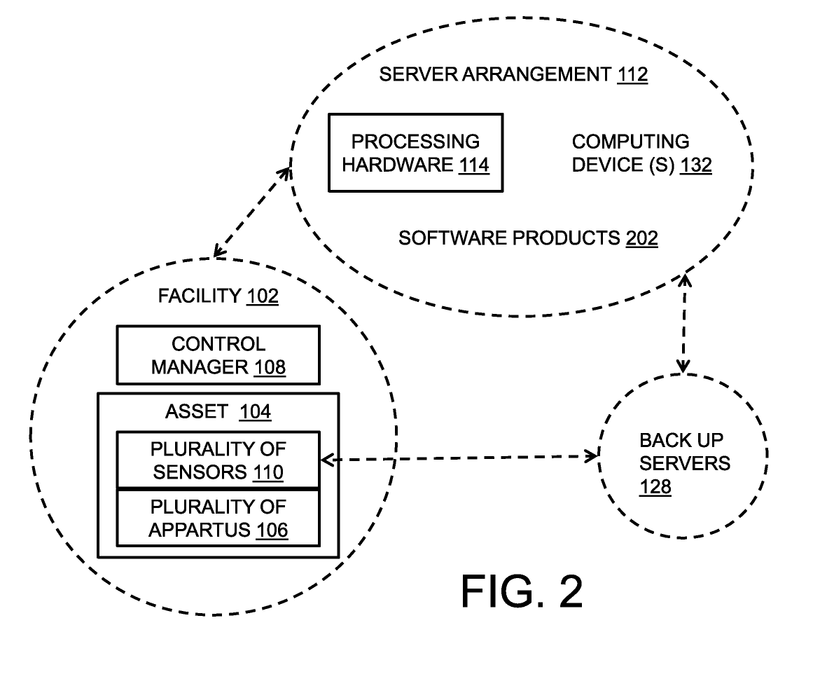

FIG. 2 is an illustration of a system for monitoring operation of an asset, in accordance with various embodiments of the present disclosure; and

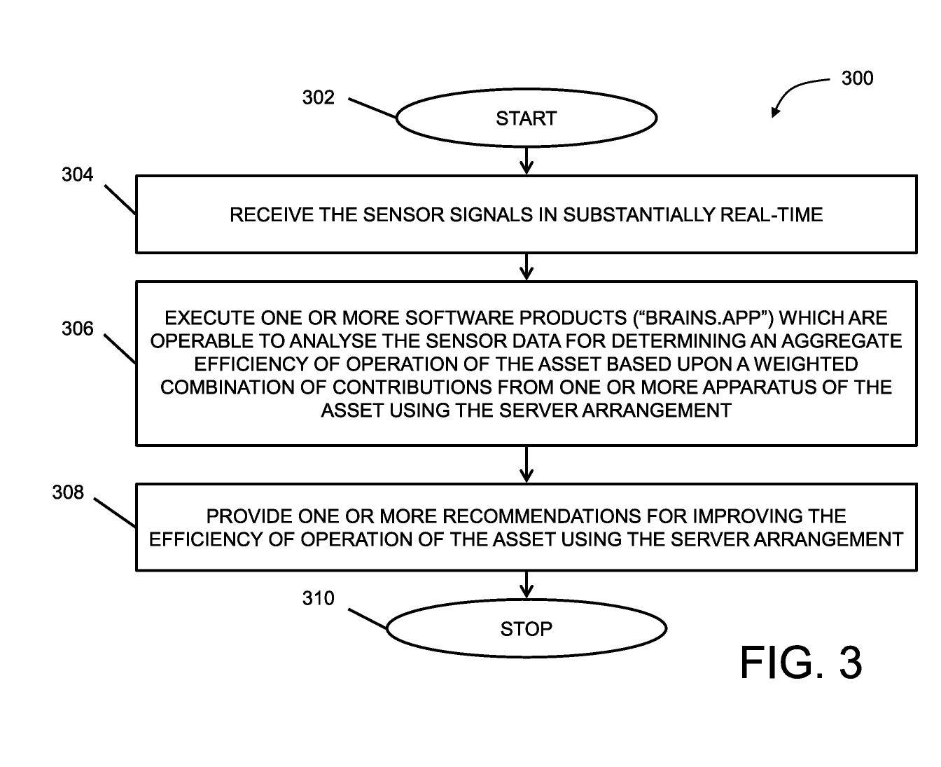

FIG. 3 is an illustration of a method for operating a system for monitoring operation of an asset, in accordance with various embodiments of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

Referring now to the aforesaid drawings, particularly with reference to their reference numbers, FIG. 1 is an illustration of a system 100 for monitoring operation of an asset 104, in accordance with various embodiments of the present disclosure. The system 100 includes a facility 102, a cloud computing environment 120, a server arrangement 112, one or more backup servers 128 and the computing devices 130. The facility 102 includes a production arrangement including the asset 104. The asset 104 has a plurality of sensors 110 to collect data from the plurality of apparatus 106. The facility 102 includes a control manager 108 which optionally has multiple software layers to control the plurality of sensors 110 and/or the plurality of apparatus 106. The plurality of sensors 110 monitors and collects the data corresponding to the status/operating conditions of the plurality of apparatus 106 of the asset 104 in real time and transmits the data in real time in a form of signals to the server arrangement 112. The one or more assets 104 make up an overall system within a facility 102 in many cases and it is the optimisation of these extensive systems that can offer energy improvements of up to more than ca 5%, preferably more than ca 15% and most preferably more than ca 25% of the overall energy consumption of an overall system. Similarly the savings in e.g. water consumption in mining installations may be reduced by more than ca 2%, preferably ca 6% and most preferably ca 10%.

In one embodiment the one or more sensors 110 are arranged in a portable, interchangeable setup that allows the sensors to be provided in a mobile kit. For example, a mobile kit for profiling well pump performance in the mining industries includes a flow rate meter and a water level sensor in the multiple sensors 110. Data from the sensors 110 are collected and logged locally and then in real time or at selected intervals transferred to the server via network connections, network (cellular) operators or a mobile data storage device such as a to smartphone, tablet or phablet computer. In one example, the system 100 has been applied to in-situ recovery mine. Combining real time flow rates and power consumption data of the submersible pumps allowed for identification of the pumps entering a “dry running” mode which is a damaging state for the pump. Real time identification of the dry running mode and addressing it by giving recommendations for the well workover timing in order to increase the well solution inflow would decrease the pump breakdown rate by about 15% and would lead to saving in energy up to about 35%.

Examples of the facility 102 include, but may not be limited to, micro-fabrication plants, manufacturing plants, steel mills, water treatment works, recovery assembly factories, power stations, oil and gas fields, quarries, mines, in-situ mining plants, water utilities, foundries, steel industry, petrochemicals industry, nuclear industry, transport facilities, water treatment works and food processing facilities. These facilities may include multiple assets having plurality of sensors to sense the parameters associated with various apparatus/machines. Examples of the asset include, but are not limited to, a mining facility employing an array of bore holes with submersible pumps in which water or other fluid is flushed in ground between the bore holes to flush out particles of matter, for example rare-earth elements, Uranium particles, Thorium particles, a manufacturing facility such as a power generating facility. In another example, the asset is a sub-section of a foundry. The subsection of foundry optionally includes multiple machines which are monitored recovery via different types of sensors. Examples of these multiple machines include, but are not limited to, pumps, fans, compressors, rock crushers, screens, transporter belts, hoppers, cooling towers, HVAC and furnaces. The plurality of sensors 110 are optionally adjusted to monitor at given intervals for collection of appropriate amounts of data.

A processing hardware 114 of the server arrangement 112 processes the sensor signals received from the plurality of sensors 110. In an embodiment of the present disclosure, as shown in FIG. 1, the processing hardware 114 generates sensor data from the sensor signals for each of the plurality of sensors 110 and transmits the corresponding sensor data for each of the plurality of sensors 110 to a cloud computing resource 124 in the cloud computing environment 120. In an embodiment of the present disclosure, as shown in FIG. 2, the processing hardware 114 generates sensor data from the sensor signals for each of the plurality of sensors 110 and feeds the corresponding sensor data to one or more of the products 202 comprising computer readable instructions which are executed in the server to arrangement 112.

In the aforementioned embodiment in which the sensor data is transmitted to the cloud computing environment 120, shown in FIG. 1, the processing hardware 114 generates a corresponding sensor data in a format which is acceptable to the cloud computing resource 124 of the cloud computing environment 120. In an embodiment of the present disclosure, the processing hardware 114 generates XML and/or RPC data files for the corresponding sensor data, and subsequently communicates the XML and/or IPC data files to the cloud computing resource 124 through the communication link 118. The communication link 118 can be Internet.

It may be noted that the term “cloud computing environment 120” refers to various evolving arrangements, infrastructure, networks, and the like that are based upon a communication network, for example the Internet or similar. The term may refer to any type of cloud, including client clouds, application clouds, platform clouds, infrastructure clouds, server clouds, and so forth. As will be appreciated by those skilled in the art, such arrangements will generally allow for use by owners or users of sequencing devices, provide software (computer program products) as a service (SaaS), provide various aspects of computing platforms as a service (Paas), provide various network infrastructures as a service (IaaS) and so forth. Moreover, included in this term should be various types and business arrangements for these products and services, including public clouds, community clouds, hybrid clouds, and private clouds. The cloud computing environment 120 includes one or more computing resources 124. These one or more computing resources 124 are pooled to serve multiple consumers, with different physical and virtual resources dynamically assigned and reassigned according to consumer demand. Examples of one or more computing resources 124 include storage, processing, memory, network bandwidth, and virtual machines. The one or more computing resources 124 optionally communicate with one another to distribute resources, and such communication and management of distribution of resources are optionally controlled by a cloud management module 126. In an embodiment of the present disclosure, certain computer program platforms may be accessed via the one or more computing resources 124 provided by the owner of the programs while other of the one or more computing resources 124 are provided by data storage companies. In an embodiment of the present disclosure, the cloud management module 126 is responsible for load management and cloud resources. The load management is optionally implemented through consideration to of a variety of factors, including user access level and/or total load in the cloud computing environment 120.

In an embodiment of the present disclosure, the one or more cloud computing resources 124 execute computer readable instructions of one or more software products 122 for analysing the sensor data for determining an efficiency of operation of the asset 104 and for providing one or more recommendations for improving the efficiency of operation of the asset 104. The recommendations may include instructions for the operator to set particular controls like valves, switches to certain positions to improve the performance of the system 100 as a whole. The one or more software products 122 trigger proactive and predictive actions/responses that are transmitted to the asset 104, thereby allowing the asset 104 to run more efficiently and accurately. More or less continuous set point recommendation for the asset 104 is provided through the operation of the BRAINS.APP software product to the operator to ensure the process runs efficiently with minimal waste or energy consumption. For example, the operator of In Situ Recovery mining facility may get recommendations from BRAINS.APP to set a number of flow restricting valves to certain setpoints in order to achieve improved flow from the injection wells to extraction wells in ISR process.

In an embodiment of the present disclosure, the data from the asset 104 is fed to one or more software products 122 comprising computer readable instructions executed by the one or more cloud computing resources 124. The one or more software products 122 are beneficially a technical platform. The real-time acquired data corresponding to the asset 104 is compared using the existing data/information/parameters associated with the asset 104 in the technical platform. The technical platform aggregates the communicated parameters and analyses it to identify performance of the asset 104 being monitored. The technical platform analyses the areas of the assets 104 where efficiency can be improved and triggers corresponding action/improvement/recommendation signals. Such analysis enables control settings to be reset for example, efficiency targets can be set, predictions can be made, and additionally efficiency implementation plans can be designed. Conveniently, the technical platform includes an overall control platform, referred to as “BRAINS.APP” that connects wirelessly to the asset 104.

In an embodiment of the present disclosure, the one or more software products 122 are operable to analyse the sensor data for determining an aggregate efficiency of operation of the asset 104 based upon a weighted combination of contributions from one or more apparatus 106 of the asset 104 and for providing one or more recommendations for improving the efficiency of operation of the asset. For example, the one or more software products 122 analyse the various parameters associated with the pump, fan, compressors, cooling tower, HVAC and furnace of the asset 104. Examples of various parameters include, but are not limited to, a combination and association of temperature, pressure, humidity, working conditions, and peak values pertaining to different operating conditions. The one or more software products 122 are provided with simulation models of the one or more apparatus 106 of the asset 104 to which the configuration of sensors 110 is applied. The simulation models are employed for identifying adjustments that improve the efficiency of operation of the asset 104.

In an embodiment of the present disclosure, the weighted combination is computed via use of one or more weighting factors. The one or more weighting factors are calculated using an analysis of historical sensor data records for determining a set of values for the one or more weighting factors which enable the aggregate efficiency to be most representative of operation of the asset 104.

In another embodiment of the present disclosure, the one or more weighting factor are determined by applying operating perturbations to operating conditions of the asset 104 and utilizing a corresponding detected change in the aggregate efficiency for iterating values of the one or more weighting factors for enabling the operating efficiency of the asset to be improved. The analysis can utilize different approaches for determining the one or more weighting factors. These different approaches techniques which include but not limited to artificial intelligence and/or neural network analysis.

In an embodiment of the present disclosure, by utilizing a simulated iterative approach and by applying small perturbations to operating settings of the asset 104, the server arrangement 112 is operable to determine from the simulations and adjusting the weighting factors to find an optimal operating state for the asset 104.

The weighting factors can be found from as sensitivity analysis and/or by neural network programmed from past historical data sets and/or updated from perturbations applied to the asset 104 in real-time.

In an embodiment of the present disclosure, the one or more software products 122 acquire data in real-time from the asset via a wireless communication network, analyses the acquired data to identify patterns and relationships in the acquired data, constructing a system model for the asset 104, applies simulation, for example Monte Carlo simulation, to determine where energy savings and/or increases in operating efficiency can be achieved and providing control information. The control information improves the efficiency of operation of the asset 104.

In an embodiment of the present disclosure, the cloud computing resource 124 generates response signals, namely containing adjustment data or recommendation, based on the analysis and/or simulation of the one or more software products 122. In addition, the one or more cloud computing resources 124 transmit the response signals and/or instructions to the control manager 108 to improve the efficiency of the operation of the asset 104. In another embodiment of the present disclosure, the one or more cloud computing resources 124 transmit the response signals and/or instructions to the server arrangement 112 and/or back-up servers 128 to maintain the records.

In yet another embodiment of the present disclosure, the one or more cloud computing resources 124 transmit the response signals and/or instructions to one or more computing devices 130 of an administrator to take appropriate actions for increasing the efficiency of the asset 104. The analysis of the aggregate consumption data is performed online via the Internet or through wireless communication to the computing devices 130. The “BRAINS.APP”, which can be in the form of a Mobile App software solution, allows an administrator to give automated or user-selected proactive and predictive instructions on how to make the overall system more efficient and achieves post-optimisation of the asset 104 or even indicates needed replacements. This provides an advantage of being able to improve maintenance and services of assets without needing to close large parts of the facility 102.

In an embodiment of the present disclosure, a record of the data signals of the plurality of sensors 110 and/or data is also stored in one or more back-up servers 128. The data signals and/or data of the plurality of sensors 110 are stored in one or more back-up servers 128 to provide data backup security in an event of an abnormal behaviour of the cloud computing environment 120.

to As aforementioned, as shown in FIG. 2, in one of the embodiments of the present disclosure, the processing hardware 114 generates sensor data from the sensor signals for each of the plurality of sensors 110 and feeds the corresponding sensor data to one or more of the software products 202 comprising computer readable instructions being executed in the server arrangement 112 itself. In this embodiment of the present disclosure, the processing hardware 114 generates XML and/or IPC data files for the corresponding sensor data, and subsequently communicates the XML and/or IPC data files to one or more computing devices 132 present in the server arrangement 112. In this embodiment, the computer readable instructions of the one or more software products 122 are executed on the one or more computing devices 132 and generate response signals, for example containing adjustment data or recommendation, according to the analysis and/or simulation mentioned above. In this embodiment, a record of the data signals of the plurality of sensors 110 and/or data is also stored in one or more back-up servers 128. The data signals and/or data of the plurality of sensors 110 are stored in one or more back-up servers 128 to provide data backup security in an event of an abnormal behaviour of the server arrangement 112.

FIG. 3 is an illustration of a flowchart 300 for operating the system 100 for monitoring operation of the asset 104, in accordance with various embodiments of the present disclosure. As described above, the system 100 includes a configuration of sensors 110 within the asset 104 for monitoring one or more physical operating parameters of the asset 104. The sensors 110 are operable to provide corresponding sensor signals for processing within the system 100. It may be noted that to explain the flow chart 300, references will be made to the system elements of FIG. 1 and FIG. 2 to explain steps of the flowchart 300. The flowchart initiates at a step 302. At a step 204, the server arrangement 112 of the system 100 receives the sensor signals in substantially real-time. The processing hardware 114 of the server arrangement 112 processes the sensor signals to generate corresponding sensor data. In an embodiment, the processing hardware 114 of the server arrangement 112 generates XML and/or IPC data files for the corresponding sensor data. At a step 206, the server arrangement 112 executes the computer readable instructions of one or more software products (“BRAINS.APP”) 122. As aforementioned, the one or more software products 122 are operable to analyse the sensor data for determining an aggregate efficiency of operation of the asset 104 based upon a weighted combination of contributions from one or more apparatus of the asset. At a step 308, the server arrangement 112 provides one or more recommendations for improving the efficiency of operation of the asset 104. As aforementioned, the one or more software products 122 are provided with simulation models of the one or more apparatus of the asset 104 to which the configuration of sensors 110 is applied. The simulation models are employed for identifying adjustments that improve the efficiency of operation of the asset 104. The flowchart 300 terminates at a step 310, although it will be appreciated that the flow-chart 300 can be repeated to provide continuous optimization.

The present disclosure provides the method and system which have many advantages. The method and system not only can compute an operating efficiency of individual apparatus in the asset, but also determine the overall aggregate efficiency of the asset at different operating conditions. The overall efficiency is calculated by considering mutually interaction of apparatus under different operating conditions. In addition, some of the weighting factors (wf) are employed to compute the aggregate efficiency. The weighting factors are determined by analysis of historical records, performing a sensitivity analysis by applying small perturbations to operating setting of the asset in real-time and the like.

Optimization implemented by a method represented by the flowchart will now be elucidated in greater detail. The system 100 is operable to provide an aggregate assessment of operating efficiency E_{agg}, which is computed, for example, from a weighted summation of individual efficiencies of apparatus, as defined by Equation 1 (Eq. 1):

$${E}_{agg} = {\sum }_{i = 1}^{n} w {f}_{i} {E}_{i} \qquad Eq . 1$$

wherein
Eᵢ=efficiency of a given apparatus with index i;
wfᵢ=weighting factor of efficiency for apparatus i;
n=a total number of apparatus being optimized by the system 100.

The aggregate assessment of operating efficiency E_{agg} provides an overall indication of an operating efficiency of a given facility. However, the apparatus are mutually interconnected and interact, such that an adjustment to an operating parameter for one given apparatus to change its efficiency, for example a change in operating pressure of a pump, will influence efficiencies of other apparatus. Thus, both the weighting factors wf and the efficiencies of the apparatus Eᵢ are functions of operating parameters of the apparatus, for example as measured by the aforesaid sensors and determine from one or more set-points applied to control the apparatus. Moreover, for correct and safe functioning of the facility, there will be certain ranges of permissible values for the sensor signals and the set-points, for example for ensuring that the facility runs safely and/or processes implemented in real-time in the facility function to required quality and/or productivity criteria.

By monitoring the apparatus, via data derived from sensor signals, the system 100 is able to compute interrelationship between the apparatus, for example via employing simulation models, for example via tables of apparatus operating characteristics, for computing the weighting factors wfᵢ. For example, the interactions between the apparatus are optionally determined by applying small test perturbations to operating parameters of the apparatus and then monitoring a responsive behaviour of the apparatus. The weighting factors wfᵢ are then computed so that aggregate assessment of operating efficiency E_{agg} provide a representative indication of a general operating efficiency of the facility, and the weighting factors wfᵢ provided insight regarding one or more critical apparatus of the facility which have a major influence on the aggregate efficiency E_{agg}, and which need to monitored and adjusted especially diligently. Further, the embodiment of the disclosure may also utilise the substantially real time data collected to be analysed for optimising the one or more assets and overall system in non-real time. This post data collection analysis where adjustments of operating parameters are introduced later on (not in real time) in the overall system allows for gradual introduction of changes. This reduces the complexity of the controlling of the overall system and also allows careful analysis of the cost implications of changed operating conditions to be weighed up against problems in performance or operation due to the changed conditions. If adjusting some operating parameters of one or more assets can save $50,000 but the risk of getting it wrong could damage $5 Million in production costs then further analysis or no adjustment would be one performed.

Determining aforesaid interrelationships between the apparatus of the facility is beneficially implemented using matrix representations of sensor signals and facility set-points, wherein matrix-solving computer program tools are employed to solve a large multitude of multi-variable simultaneous equations represented by such matrices. Such matrix-solving tools are beneficially employed in the one or more cloud computing resources 124 whereat distributed array processors are available which are especially well adapted for matrix manipulation and associated solving.

In a further embodiment of the disclosure, the system is used to design an optimum maintenance schedule that is linked to the one or more apparatus and one or more individual asset and further the overall system performance and efficiency. Currently most maintenance schedules are done based on the schedule of the maintenance team and not linked to the equipment condition. A condition based preventive and predictive maintenance process, which utilises the collected data from the one or more assets or the overall system may be used to improve on the life of apparatus and components or wear parts of the assets in the overall system. Based on real time tracking of the system through wireless sensors and asset efficiency, a baseline efficiency is calculated which is used as a trigger to identify the typical maintenance cycle. If the performance of the asset drops below the baseline at a given instance or for extended time during an analysed period notifications are sent to the system for actions to be initiated to improve on the maintenance schedule. Tolerances of the base line may be set for different sensitivity depending on the type of asset like a pump, compressor, furnace, cooling tower, rock crusher, transporter belt, material screens, or other suitable apparatus. This cycle is then used to predict future maintenance cycles of the system and asset saving time, cost and resources. Further, the improved maintenance schedule may also be linked in with Enterprise Resource Planning (ERP) systems of the manufacturing plant or other installation to optimise the overall efficiency. For example, in the use in an in-situ mining process the maintenance of the well and a submersible pump is scheduled by the BRAINS.APP by processing substantially real time data of the flow rates and power consumptions of the pump. For example, a time series analysis model is employed based on the principle of a Kalman filter in order to estimate “true” state of the pump on the basis on incoming noisy measurement from the sensors. A prediction is then made about optimal maintenance cycle that provide the stable pump output and keep the production within the target interval.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A system for monitoring operation of an asset, comprising:
a configuration of sensors within the asset for monitoring one or more physical operating parameters of the asset, wherein the sensors are operable to provide corresponding sensor signals for processing within the system;
a server arrangement which is operable to receive the sensor signals in substantially real-time, wherein the server arrangement includes processing hardware for processing the sensor signals and is operable to execute computer readable instructions of one or more software products which, when executed by the system, are operable to analyse the sensor data to determine an aggregate efficiency of operation of the asset based upon a weighted combination of contributions from one or more apparatus of the asset, and to provide one or more recommendations for improving the efficiency of operation of the asset;
wherein the one or more software products are provided with simulation models of the one or more apparatus of the asset to which the configuration of sensors is applied; and
wherein the simulation models are employed for identifying adjustments that improve the efficiency of operation of the asset and overall system of one or more assets.

2. The system as set forth in claim 1, wherein the weighted combination is computed using one or more weighting factors determined from at least one of:
(a) an analysis of historical sensor data records for determining a set of values for the one or more weighting factors which enable the aggregate efficiency to be most representative of operation of the asset; and
(b) an application of operating perturbations to operating conditions of the asset and utilizing a corresponding detected change in the aggregate efficiency for iterating values of the one or more weighting factors, for enabling the operating efficiency of the asset to be improved.

3. The system as set forth in claim 2, wherein the analysis of historical sensor data records utilizes artificial intelligence, neural network analysis or both for determining the one or more weighting factors.

4. The system as set forth in claim 1, further comprising one or more backup servers for storing, as data backup security in an event of data failure or corruption within the cloud-computing resource, a record of the sensor signals, the sensor data or both.

5. The system as set forth in claim 1, wherein one or more of the sensors of the configuration of sensors is coupled wirelessly to the server arrangement.

6. The system as set forth in claim 1, wherein the system is operable to maintain a temporal record of the sensor signals, the sensor data or both.

7. The system as set forth in claim 1, wherein the system is operable to detect one or more apparatus of the asset monitored by the configuration of sensors, for determining whether the one or more apparatus are operating correctly.

8. The system as set forth in claim 1, wherein the system is operable to provide a condition-based maintenance plan for the one or more assets and overall system.

9. A method of operating a system for monitoring operation of an asset, wherein the system includes a configuration of sensors within the asset for monitoring one or more physical operating parameters of the asset, wherein the sensors are operable to provide corresponding sensor signals for processing within the system,
characterized in that the method includes:
(a) using a server arrangement to receive the sensor signals in substantially real-time, wherein the server arrangement includes processing hardware for processing the sensor signals; and
(b) using the server arrangement to execute one or more computer readable instructions of software products which, when executed on the system, are operable to analyse the sensor data to determine an aggregate efficiency of operation of the asset based upon a weighted combination of contributions from one or more apparatus of the asset, and to provide one or more recommendations for improving the efficiency of operation of the asset, wherein the one or more software products are provided with simulation models of the one or more apparatus of the asset to which the configuration of sensors is applied, and wherein the simulation models are employed for identifying adjustments that improve the efficiency of operation of the asset.

10. The method as set forth in claim 9, wherein the weighted combination is computed using one or more weighting factors determined from at least one of:
(a) an analysis of historical sensor data records for determining a set of values for the one or more weighting factors which enable the aggregate efficiency to be most representative of operation of the asset; and
(b) an application of operating perturbations to operating conditions of the asset and utilizing a corresponding detected change in the aggregate efficiency for iterating values of the one or more weighting factors, for enabling the operating efficiency of the asset to be improved.

11. The method as set forth in claim 9, wherein the method includes using cloud-computing resource to execute the one or more computer readable instructions for analysing the sensor data to determine an efficiency of operation of the asset and provide one or more recommendations for improving the efficiency of operation of the asset.

12. The method as set forth in claim 9, wherein the method includes providing the one or more software products with simulation models of one or more apparatus of the asset to which the configuration of sensors is applied, wherein the simulation models are employed for identifying adjustments that improve the efficiency of operation of the asset.

13. The method as set forth in claim 9, wherein the method further includes using one or more backup servers to store, as data backup security in an event of data failure or corruption within the cloud-computing resource a record of the sensor signals, the sensor data or both.

14. The method as set forth in claim 9, wherein one or more of the sensors of the configuration of sensors is coupled wirelessly to the server arrangement.

15. The method as set forth in claim 9, further comprising operating the system to maintain a temporal record of the sensor signals, the sensor data or both.

16. The method as set forth in claim 9, further comprising operating the system to detect one or more apparatus of the asset monitored by the configuration of sensors to determine whether the one or more apparatus are operating correctly.

17. A computer program product recorded on non-transient machine-readable data storage media, the computer program product including computer readable instructions which, when executed by one or more computers, causes the one or more computers to:
analyse the sensor data to determine an aggregate efficiency of operation of the asset based upon a weighted combination of contributions from one or more apparatus of the asset; and
provide one or more recommendations for improving the efficiency of operation of the asset, wherein the one or more computer readable instructions are provided with simulation models of the one or more apparatus of the asset to which the configuration of sensors is applied, and wherein the simulation models are employed for identifying adjustments that improve the efficiency of operation of the asset.
